(19) United States
(12) Patent Application Publication
(10) Pub. No.: US 2023/0161607 A1
(43) Pub. Date: May 25, 2023

(54) SCREEN-POP CONFIGURATION USING FLOW BUILDER APPLICATION

(71) Applicant: salesforce.com, inc., San Francisco, CA (US)

(72) Inventors: Peng-Wen Chen, Foster City, CA (US); Wenqing Dai, Richmond, CA (US); Priyank Saxena, Danville, CA (US); Vincent Pham, Pleasanton, CA (US); Neil Armstrong, Chicago, IL (US); Keshav Rajan, Seattle, WA (US); Archana Vanam, Pleasanton, CA (US); Nandini Suresh Kumar, San Francisco, CA (US)

(21) Appl. No.: 17/456,366

(22) Filed: Nov. 23, 2021

(51) Int. Cl. G06F 9/451; G06F 8/34; G06F 16/9038

(52) U.S. Cl. CPC G06F 9/451; G06F 8/34; G06F 16/9038; G06Q 30/016

(57) ABSTRACT

Methods, systems, apparatuses, devices, and computer program products are described. An application server may receive a set of parameters for configuring a user interface screen-pop for an application via a user input of a flow builder application. The screen-pop may include a visual feature that appears in a user interface of the application in response to a trigger. The application server may store instructions for implementing the screen-pop as a process flow according to the flow builder application and execute the process flow in response to receiving an indication of the trigger from the application, and in accordance with metadata associated with the trigger. In some examples, the application server may store the output of the process flow execution in a database and query the database for the instructions. The application server may send instructions for displaying the screen-pop to the application based on the indication of the trigger.

### FIELD OF TECHNOLOGY

The present disclosure relates generally to database systems and data processing, and more specifically to screen-pop configuration using flow builder application.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform (or another platform) may support applications that utilize screen-pops (e.g., user interface screen-pops) to navigate a user to a particular view state in an application. For example, in a telephony-integrated application, a screen-pop may be displayed in a new view state (e.g., a tab, a browser window, a page, an overlay) to provide contextual information to the user based on a trigger. In some cases, however, screen-pop implementations may be configured based on statically-defined metadata, which may limit the functionality and configurability of the screen-pop configuration.

### BRIEF DESCRIPTION OF THE DRAWINGS

FIG. 1 illustrates an example of a user interface configuration system that supports a screen-pop configuration using flow builder application in accordance with aspects of the present disclosure.

FIGS. 2 through 4 illustrate examples of systems that support a screen-pop configuration using flow builder application in accordance with aspects of the present disclosure.

FIGS. 5 and 6 illustrate examples of process flows that support a screen-pop configuration using flow builder application in accordance with aspects of the present disclosure.

FIG. 7 shows a block diagram of an apparatus that supports a screen-pop configuration using flow builder application in accordance with aspects of the present disclosure.

FIG. 8 shows a block diagram of a screen-pop component that supports a screen-pop configuration using flow builder application in accordance with aspects of the present disclosure.

FIG. 9 shows a diagram of a system including a device that supports a screen-pop configuration using flow builder application in accordance with aspects of the present disclosure.

FIGS. 10 through 13 show flowcharts illustrating methods that support a screen-pop configuration using flow builder application in accordance with aspects of the present disclosure.

### DETAILED DESCRIPTION

Techniques described herein support configuring a screen-pop using a flow builder application, where the screen-pop may be a visual feature that appears in a user interface in response to a trigger. In particular, techniques depicted herein provide for a dynamically-configured screen-pop that users can configure using a low-code, declarative flow, which enables creation of complex screen-pop configurations using a flow-builder interface. In some cases, the screen-pop may display one or more records associated with a trigger. For example, in a telephony-integrated application, a user may accept an inbound voice call. Based on the user accepting an inbound voice call (e.g., a trigger), the application (e.g., the telephony-integrated application) may display a screen-pop which may navigate the user to a meaningful view (e.g., a tab, a browser window, a page) to provide contextual information to the user. Some applications may support dynamic records associated with the trigger. However, some screen-pop implementations may be configured based on statically-defined metadata, which may limit the screen-pop configuration and fail to include the dynamic records. For example, the statically-defined metadata may prevent a user from configuring a condition upon which a screen-pop is triggered and what information is screen-popped when the condition is satisfied. As such, techniques for dynamically configuring a screen-pop may be utilized to display a contextual and effective screen-pop to a user in an application.

Specifically, the techniques described herein integrate an application server and a user interface for an application such that a screen-pop may be configured and displayed to the application based on parameters associated with a trigger. A server (e.g., an application server or some other similar computing device) may receive a first set of parameters for configuring a screen-pop (e.g., a user interface screen-pop) for an application (e.g., a telephony-integrated application) via a user input of a flow builder application. The screen-pop may be a synchronous screen-pop and may include a visual feature that appears (e.g., as an overlay or navigated to another tab) in a user interface of the application in response to the trigger. In some cases, the application server may store instructions for implementing the screen-pop as a process flow according to the flow builder application. The application server may execute the process flow in response to receiving an indication of the trigger from the application, and in accordance with metadata associated with the trigger. In some examples, the application server may send instructions for displaying the screen-pop to the application based on the indication of the trigger, and the application may display the screen-pop according to the instructions. As such, described techniques enable a user to use a low-code and/or declarative user interface of a flow builder application to configure conditions upon which a screen-pop is triggered and what is screen-popped when the conditions are met.

In some examples, for an asynchronous screen-pop, the application server may store an output of the process flow as instructions (e.g., in the form of instruction records) corresponding to the screen-pop in a database. Based on one or more characteristics associated with the trigger, the application server may query the database for the instruction records and send the instructions for displaying the screen-pop based on querying the database. As such, the application server may dynamically configure a synchronous screen-pop, an asynchronous screen-pop, or both using the process flow to increase the overall performance and efficacy of the screen-pop.

Aspects of the disclosure are initially described in the context of an environment supporting an on-demand database service. Aspects of the disclosure are then described in the context of systems and process flows. Aspects of the disclosure are further illustrated by and described with reference to apparatus diagrams, system diagrams, and flowcharts that relate to screen-pop configuration using flow builder application.

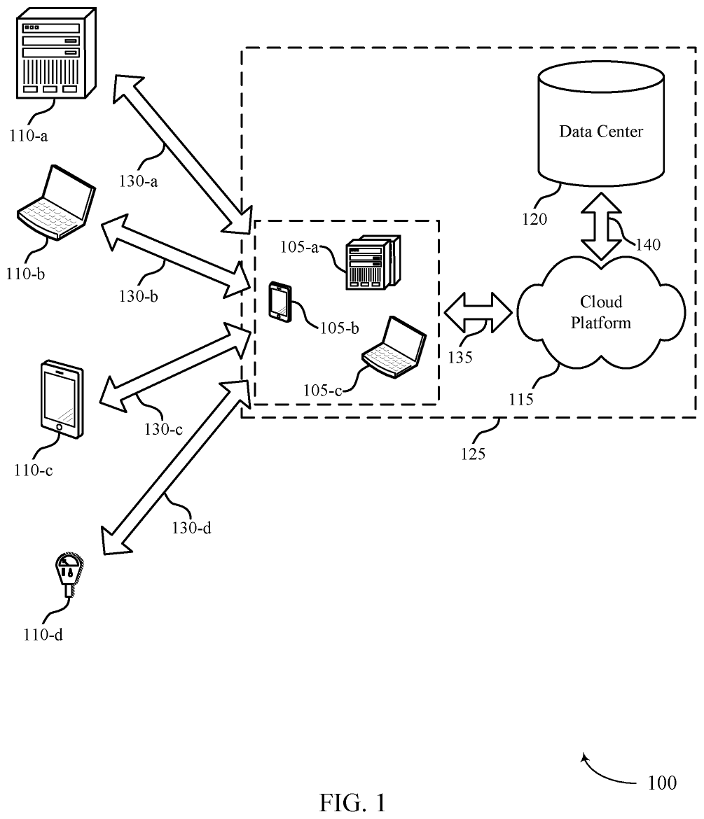

FIG. 1 illustrates an example of a system 100 for cloud computing that supports a screen-pop configuration using flow builder application in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to particular applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud platform 115 and/or the subsystem 125 may support an application server, which may be used to dynamically configure a screen-pop using a flow builder application. The screen-pop may be a visual feature that appears in a user interface of an application in response to a trigger. In some examples, the application sever may support various actions that may be used to configure a screen-pop, including retrieving data records, making decisions based on the data records, performing screen-pops, or any combination thereof. In some examples, the application server perform the actions based on user input received via a user device. When a screen-pop is configured, the application server may route the screen-pop through an additional application server in communication with an additional user device to be displayed on a user interface of the additional user device. Alternatively, the screen-pop may be configured with and displayed at the same user device.

As depicted herein, a screen-pop may be a user interface operation which may navigate (e.g., redirect) a user from one view state to another in an application to facilitate an interaction. Screen-pops may be used in telephony-integrated applications to navigate users to a meaningful state after receiving an inbound call or making an outbound call. Additionally or alternatively, screen-pops may be leveraged to provide contextual information to users at a point in time that the application may deem appropriate. For example, an application may screen pop a home page (e.g., Record Home page) of a record (e.g., a Contact record) representing a calling customer end user alongside a call record page (e.g., a VoiceCall Record Home page) when a contact center agent receives an inbound voice call. In some cases, the application may screen-pop the three most received cases associated with the customer end user to provide additional context to the contact center agent participating in the voice call. In addition, the application may screen-pop a contact record as a subtab of its corresponding parent account record.

In some examples, screen-pop implementations may use statically-defined metadata to configure how a screen-pop may be performed. For example, the statically-defined metadata may configure whether the screen-pop is displayed inside an existing window or in a new window, what the screen-pop includes based on whether there are no matching records, one matching record, or multiple matching records, and what predefined target device the screen-pop may be displayed to. As such, the statically-defined metadata may include a predetermined number of rules used to configure a screen-pop. In some cases, the screen-pop configuration functionalities may be limited because it is based on the statically-defined metadata. For example, a user may be unable to configure a screen-pop to be triggered when a calling customer end user has contacted a business at least once about an issue for a particular product in a given time period (e.g., the last 30 days). In addition, users may be unable to specify screen-pop targets including records that may be indirectly related to a context record, customer-defined artifacts, or both, which may result in workflow inefficiencies and limited screen-pop performance capabilities.

Techniques described herein and supported by the system 100 may support a screen-pop configuration using a flow builder application, where the screen-pop may be supported by the cloud platform 115 and an external user interface and corresponding user device. For example, a user associated with an application (e.g., a telephony-integrated application) may use an application server to build a process flow according to a flow builder application, where the process flow may include instructions for implementing a screen-pop for the application. The application server may include tools to configure the screen-pop using a process flow, and the process flow may include logic to obtain records, make decisions, and perform actions (e.g., screen-pops) based on a trigger and corresponding parameters. In some examples, the application server may route a screen-pop to a user device associated with the application, and the application may display the screen-pop in a user interface of the application.

The cloud platform 115 may integrate components of a system, including an application server, a screen-pop service, a flow engine, and a user interface and a corresponding user device such that a screen-pop may be configured and displayed to the application based on parameters associated with a trigger. The application server may receive a first set of parameters for configuring a screen-pop (e.g., a user interface screen-pop) for an application (e.g., a telephony-integrated application) via a user input of a flow builder application. The screen-pop may be a synchronous screen-pop which may include a visual feature that appears in a user interface of the application in response to a trigger. In some cases, the application server may store instructions for implementing the screen-pop as a process flow according to the flow builder application. The application server may execute the process flow in response to receiving an indication of the trigger from the application, and in accordance with metadata associated with the trigger. In some examples, the application server may send instructions for displaying the screen-pop to the application based on the indication of the trigger, and the application may display the screen-pop according to the instructions. As such, described techniques enable a user to configure conditions upon which a screen-pop may be triggered and what may be screen-popped when the conditions are met.

Dynamically configuring a screen-pop using a process flow and flow builder application may support improved workflow efficiencies and improved user experience by providing a contextual screen-pop to a user based on a trigger and corresponding parameters. For example, as the techniques described herein support configuring a condition upon which a screen-pop may be displayed, the techniques may support improved workflow efficiencies by providing specific rather than generic screen-pops at specific times. As another example, the techniques described herein support providing an accurate screen-pop to a corresponding user, which may support improved user experience by implementing meaningful screen-pops with contextual information. Additionally, the described techniques support reduced overhead associated with providing a dynamic flow builder application tool regardless of specific implementations.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

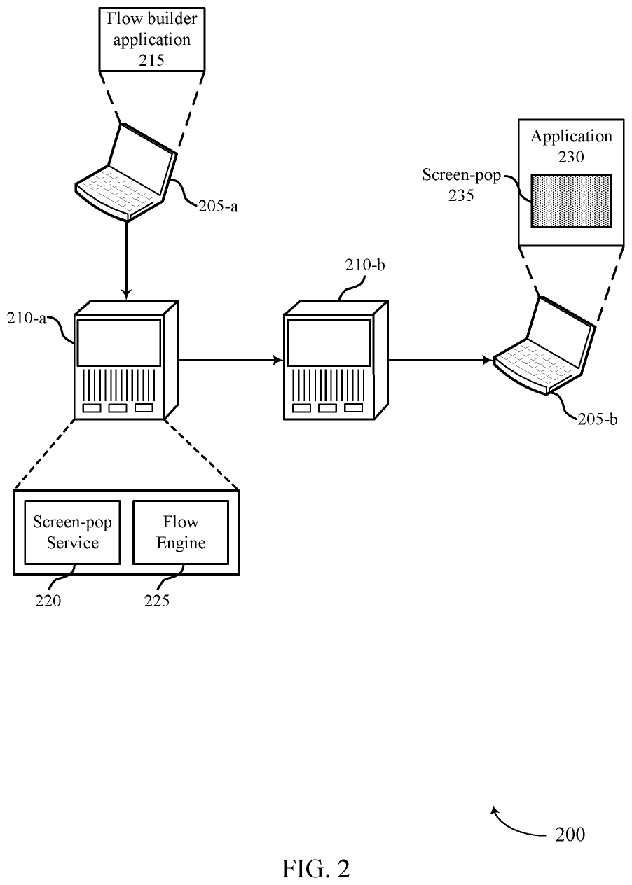

FIG. 2 illustrates an example of a system 200 that supports a screen-pop configuration using flow builder application in accordance with aspects of the present disclosure. The system 200 may be an example of a system 100 or a subsystem 125 as described with reference to FIG. 1. The system 200 may include user devices 205 which may be in communication with application servers 210. A user, operating a user device 205, may send requests to an application server 210 to obtain records, communicate with another user device 205, perform an action (e.g., a screen-pop), or any combination thereof. A user device 205 may be an example of a cloud client 105 as described with reference to FIG. 1. In some cases, an application server 210-a may include a screen-pop service 220 and a flow engine 225, which may identify and execute a process flow to configure and display a screen-pop 235 (e.g., a user interface screen-pop).

As described herein, the system 200 may support configuring and executing the screen-pop 235 using a process flow. For example, the described techniques may enable a user to build a process flow according to the flow builder application 215 on a user device 205-a. In some examples, the flow builder application 215 may be a declarative user interface including drag and drop features, a canvas, or any combination thereof. A user may utilize the flow builder application 215 to build the process flow. The process flow may be a low-code, declarative technology which may enable for simple or complex screen-pop configurations, including flexible design-time functionalities. The process flow may be channel agnostic such that it may be based on inputs from a voice channel, a messaging channel, an email channel, or any other channel.

The screen-pop 235 may be a visual feature that appears in a user interface of an application 230 (e.g., a telephony-integrated application) on a user device 205-b. For example, the screen-pop 235 may be an additional tab, browser window, or page (e.g., a user interface artifact) that pops up in the application 230 of the user device 205-b to display a particular record based on a trigger. That is, the screen-pop 235 may pop up in the application 230 in addition to (e.g., overlaying) a tab, a browser window, or a page the user is already viewing on the user device 205-b. In some examples, in addition to screen-popping a record, the process flow may configure the target of the screen-pop 235 as a URL, an external page, a custom-created page or component, or any combination thereof.

In some examples, the application server 210-a may receive, via a user input of the flow builder application 215, a set of parameters for configuring the screen-pop 235 for the application 230 at the user device 205-b. The screen-pop 235 may appear in the user interface of the application 230 in response to a trigger. The trigger may be associated with at least one channel, such as a voice channel (e.g., an inbound voice call, an outbound voice call, a callback call), a chat channel, a messaging channel, or any combination thereof. Additionally or alternatively, the trigger may include dynamic information that may be provided in addition to the channel trigger. For example, the trigger may include an inbound call with customer information, order information provided through an interactive voice response (IVR), or the like. In some examples, the trigger may include an inbound voice call, a customer identifier associated with the inbound voice call, a membership status for a customer, an order number input, an order modification input for a product, an outbound call associated with a prior callback request, a time period between a timing of the prior callback request and a timing of the outbound call, case information, or any combination thereof. In some cases, the set of parameters may include information such as a context record identifier, which may be associated with the trigger. For example, if the trigger is an inbound voice call to a customer service agent using the user device 205-b, the context record may be a voice call record identifier linked to a record including information such as the phone number used to make the inbound voice call.

The screen-pop service 220 may use the set of parameters as input variables for configuring the screen-pop 235 using a process flow. In some examples, the screen-pop service 220 may identify a process flow from a set of stored process flows (e.g., a set of flow definitions) based on receiving the set of parameters. For example, the screen-pop service 220 may identify a process flow from the set of stored process flows that includes input variables similar to or the same as the received parameters. Additionally or alternatively, the screen-pop service 220 may build a process flow or modify the identified process flow based on other input variables. In some examples, the screen-pop service 220 may identify the process flow from the set of stored process flows based on one or more characteristics associated with the trigger. For example, if the trigger is an inbound voice call via a voice channel, the screen-pop service 220 may identify a process flow to configure the screen-pop 235 that considers characteristics associated with the inbound voice call. The process flow may include logic to obtain records, make decisions, perform actions (e.g., screen-pops), or any combination thereof. As such, the screen-pop service 220 may store instructions for implementing the screen-pop 235 in the process flow.

The flow engine 225 may execute the process flow in response to receiving an indication of the trigger from the application 230 in accordance with metadata associated with the trigger. For example, the application server 210-a may receive an indication of a trigger (e.g., the inbound voice call) from a customer for the customer service agent using the application 230. As the screen-pop service 220 built the process flow based on parameters (e.g., the metadata) associated with the trigger, the flow engine 225 may execute the process flow to determine whether or not to display the screen-pop 235 to the user device 205-b when the trigger occurs. In some examples, the flow engine 225 may execute logic in the process flow to obtain one or more records associated with the set of parameters used as input variables in the process flow. If the flow engine 225 successfully obtains the one or more records, then the flow engine 225 may determine to screen-pop those records to the user device 205-b. Additionally or alternatively, the process flow may include logic that may reference additional data records (e.g., CRM records) that may include dynamic information (e.g., particular details associated with the trigger). The flow engine 225 may use the additional data records to determine whether to display the screen-pop 235.

After executing the process flow to determine whether to screen-pop one or multiple records for the application 230, the flow engine 225 may return the output of the process flow execution back to the screen-pop service 220. The output may indicate the one or more records to be screen-popped, the targets of the screen-pops, and other information related to displaying the screen-pops. In some cases, the screen-pop service 220 may transform the output of the flow execution to a set of instructions for displaying the screen-pop 235 to the application 230. The screen-pop service 220 may send the instructions for displaying the screen-pop 235 to the application 230 based on the indication of the trigger, and the screen-pop 235 may be displayed once the trigger occurs. In some examples, the screen-pop service 220 may route the instructions for displaying the screen-pop 235 through the application server 210-a to the application server 210-b, which may be in communication with the user device 205-b.

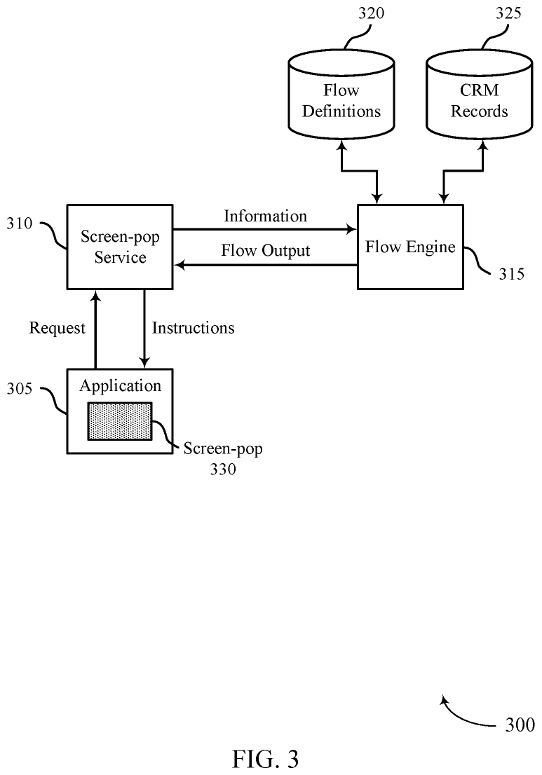

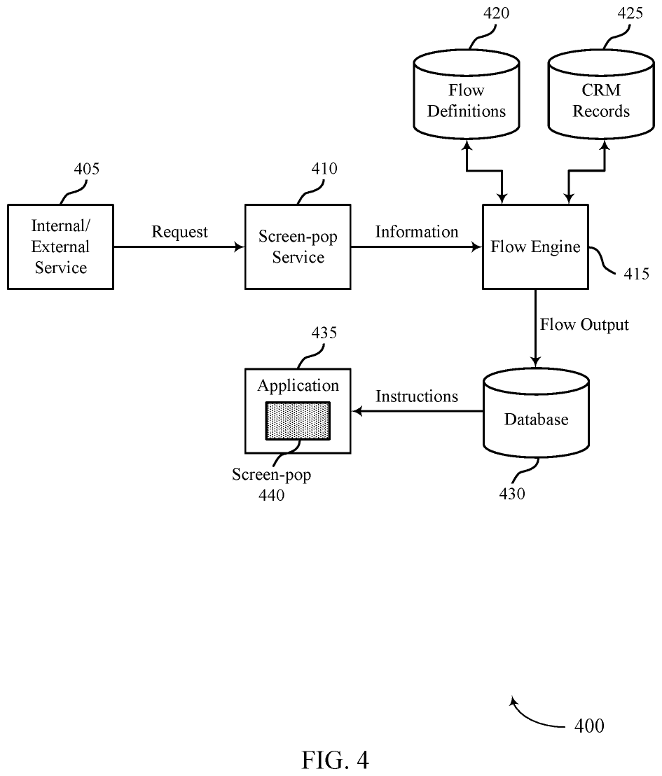

As described with reference to FIGS. 3 and 4, the screen-pop 235 may be a synchronous screen-pop or an asynchronous screen-pop. For example, if the screen-pop 235 is synchronous, the process flow may be built and executed in response to an indication of a trigger, and the output of the process flow may be immediately converted to instructions for displaying the screen-pop 235 in response to the trigger. If the screen-pop 235 is asynchronous, the process flow may be built and executed in response to the indication of the trigger, and the output of the process flow may be stored in a database as the instructions for displaying the screen-pop 235 until the application 230 receives an indication of the trigger and queries the database for the instructions.

In some cases, the instructions for displaying the screen-pop 235 at the user device 205-b may include at least one of a context record, a target type, a target configuration, an focus indication, or any combination thereof. The context record (e.g., foreignkey, “ContextRecord”) may indicate a record for which instructions for displaying the screen-pop 235 may be applied. The target type (e.g., enum, “TargetType”) may indicate a type of an artifact targeted for the screen-pop 235 (e.g., RecordHome, a URL, or the like). The target configuration (e.g., text, “TargetConfig”) may indicate a JavaScript Object Notation (JSON) string including settings used to render the specified screen-pop target artifact (e.g., a record identifier, an application programming interface (API) name, a URL). The focus indication (e.g., Boolean, “IsFocused”) may indicate whether the target receiving the screen-pop 235 is focused or unfocused.

In some examples, configuring the screen-pop 235 using the process flow based on a set of parameters may improve the flexibility and functionality of the screen-pop 235. For example, during a customer service call, multiple records may be screen-popped to a customer service agent to provide relevant information that may better serve the customer. For example, the screen-pop service 220 may be associated with a company. The screen-pop service 220 may receive an inbound voice call (e.g., a trigger), where the calling user (e.g., a customer end user) may be a premium member of the company (e.g., indicated as data on the matched contact record). Additionally or alternatively, the calling user may have indicated that the purpose of the call is to modify a product order (e.g., indicated in data from an IVR). Based on these input parameters, the screen-pop service 220 may include logic in the process flow to screen-pop the matched contact record (e.g., focused), the details of the most recent order made by the calling user, and a knowledge article providing promotional information for a product which is similar or related to the product included in the calling user's most recent order.

In another example, a customer service agent may perform an outbound voice call addressing a prior callback request (e.g., if a customer chose to be called back at a later time instead of waiting for a call to be picked up by the agent). The screen-pop service 220 may retrieve input parameters indicating that the callback request is about addressing a product issue (e.g., indicated as data in the callback record), the current time if the callback request time happened more than an hour prior (e.g., indicated as data in the callback record), and that the calling customer has filed more than two cases in the last thirty days (e.g., indicated as data in contact and case records). Based on these input parameters, the screen-pop service 220 may include logic in the process flow to screen-pop a screen-flow enabling the customer service agent to get an approval from their manager to offer a special discount to the customer and a knowledge article providing information on how to handle a customer belonging to a particular category (e.g., focused).

In some examples, the application server 210-a may maintain a record (e.g., a log) of the instructions processed in the process flow to configure a screen-pop 235. For example, the record may include how many screen-pops are created, how many records are screen-popped, and how long it takes to perform the screen-pop 235, among other instrumentation records. In some examples, a user may generate a report to understand performance and usage metrics such as how many records are screen-popped, how many times a particular record is screen-popped, how many screen-popped records are used for different channels, or any combination thereof.

FIG. 3 illustrates an example of a system 300 that supports a screen-pop configuration using flow builder application in accordance with aspects of the present disclosure. The system 300 may be implemented by the application servers 210 described herein with reference to FIG. 2, and may support configuring screen-pops (e.g., user interface screen-pops) using a flow builder application. For example, the system 300 may include an application 305, a screen-pop service 310, a flow engine 315, flow definitions 320, and CRM records 325, which may be used to configure and display a synchronous screen-pop.

A user (e.g., a customer service agent) may interact with the application 305 (e.g., a telephony-integrated application). The user may perform an operation which may trigger one or more records to be screen-popped in response to the trigger (e.g., a synchronous screen-pop). For example, the user may receive an inbound voice call (e.g., from a customer). Prior to the user accepting the call, the screen-pop service 310 and the flow engine 315 may build and execute a process flow to configure a screen-pop 330 such that one or more records associated with the call may be screen-popped to the application 305 when the user accepts the call (e.g., the trigger).

In some cases, the user may use the application 305 to initiate a request to the screen-pop service 310 to build the screen-pop 330 for display within the user interface of the application 305. The request may include an indication of a trigger and contextual information corresponding to the trigger such as a context record identifier. For example, the user may receive an input from a channel (e.g., a voice channel, a messaging channel), which may include a set of parameters (e.g. the context record identifier) associated with the input. The screen-pop service 310 may identify and build a process flow using the contextual information as input variables for the process flow. As described with reference to FIG. 2, the process flow may include logic for obtaining records, making decisions, performing actions (e.g., screen-pops), or any combination thereof. In some examples, the screen-pop service 310 may identify a process flow from a set of stored process flows and flow definitions 320 that is registered with the particular request from the user. That is, the screen-pop service 310 may identify a process flow using generic rules from the flow definitions 320 and add additional logic to the identified process flow using the contextual information.

After the screen-pop service 310 builds the process flow, the flow engine 315 may execute the process flow. In some examples, the flow engine 315 may use the contextual information (e.g., the input variables) to obtain matching records associated with the application 305. Additionally or alternatively, the flow engine 315 may execute logic in the process flow that may reference the CRM records 325 to determine if the requested screen-pop may occur. For example, the screen-pop service 310 may retrieve a set of parameters associated with the CRM records 325, which may include dynamic information (e.g., history of a particular customer), and the screen-pop service 310 may use the CRM records 325 and/or the set of parameters associated with the CRM records 325 to build additional logic into the identified process flow. The flow engine 315 may use the CRM records 325 to make a decision in the process flow regarding whether to screen-pop one or more records (e.g., target artifacts such as a record home page). After executing the process flow, the flow engine 315 may return the output of the process flow execution back to the screen-pop service 310. The output of the process flow execution may include an operation configuration for the screen-pop 330, for example, indicating the one or more records to be screen-popped and one or more targets for the screen-pops.

The screen-pop service 310 may transform the output of the process flow execution to a set of instructions for displaying the screen-pop 330, which the screen-pop service 310 may send to the application 305. The instructions may indicate the one or more records being screen-popped and information about the target of the screen-pop (e.g., a tab, a browser window, a page in the application 305). The application 305 may receive the instructions and perform the screen-pop 330 accordingly in response to the trigger.

FIG. 4 illustrates an example of a system 400 that supports a screen-pop configuration using flow builder application in accordance with aspects of the present disclosure. The system 400 may be implemented by the application servers 210 described herein with reference to FIG. 2, and may support configuring screen-pops (e.g., user interface screen-pops) using a flow builder application. For example, the system 400 may include an internal/external service 405, a screen-pop service 410, a flow engine 415, flow definitions 420, CRM records 425, a database 430, and an application 435, which may configure and execute an asynchronous screen-pop.

A user (e.g., a customer) may interact with the internal/external service 405, which may include a voice channel, a messaging channel, or another type of channel. The user may initiate a request to the screen-pop service 410 to perform a screen-pop 440 (e.g., an asynchronous screen-pop) within the application 435 (e.g., a telephony-integrated application) using the internal/external service 405. For example, a customer may use the internal/external service 405 to send a voice call to user (e.g., a customer service agent) using the application 435. Upon receiving the request, the screen-pop service 410 and the flow engine 415 may build and execute a process flow to configure the screen-pop 440 such that one or more record associated with the request may be screen-popped to the application 435 when the screen-pop 440 may be relevant for the application 435.

In some cases, the request to display the screen-pop 440 within the user interface of the application 435 may include an indication of a trigger and contextual information corresponding to the trigger, such as a context record identifier. For example, the internal/external service 405 may include a set of parameters associated with the request (e.g., the context record identifier). The screen-pop service 410 may identify and build the process flow using the set of parameters as input variables for the process flow. As described with reference to FIG. 2, the process flow may include logic for obtaining records, making decisions, performing actions (e.g., screen-pops), or any combination thereof. In some examples, the screen-pop service 410 may identify a process flow from a set of stored process flows and flow definitions 420 that is registered with the particular request from the user. That is, the screen-pop service 410 may identify a process flow using generic rules from the flow definitions 420 and add additional logic to the identified process flow using the contextual information.

After the screen-pop service 410 builds the process flow, the flow engine 415 may run the process flow. In some examples, the flow engine 415 may use the set of parameters (e.g., the input variables) to obtain matching records associated with the application 435. Additionally or alternatively, the flow engine 415 may execute logic in the process flow that may reference the CRM records 425 to determine if the requested screen-pop may occur. For example, the screen-pop service 410 may retrieve a set of parameters from the CRM records 425, which may include dynamic information (e.g., history of a particular customer), and use the CRM records 425 to build additional logic into the identified process flow. The flow engine 415 may use the CRM records 425 to make a decision in the process flow regarding whether to screen-pop one or more records (e.g., target artifacts such as a record home page).

After executing the process flow, the flow engine 415 may store the output from the process flow execution as the screen-pop instruction records in a database 430 (e.g., a persistent storage database), where the screen-pop instructions correspond to the screen-pop 440. Based on the set of parameters included in the request from the internal/external service 405, the application 435 may query the database 430 for the screen-pop instructions. In some examples, instead of displaying the screen-pop 440 to the application 435 immediately in response to a trigger, the application 435 may query the database 430 for the screen-pop instructions, and the application 435 may perform the screen-pop 440 according to the screen-pop instructions when a screen-pop may be relevant for the application 435. For example, before an inbound voice call from the internal/external service 405 is routed to a user using the application 435 (e.g., a customer service agent), the screen-pop instructions may already be written to the database 430. As such, the screen-pop 440 may be rendered when the user accepts the inbound voice call and queries the database for the screen-pop instructions.

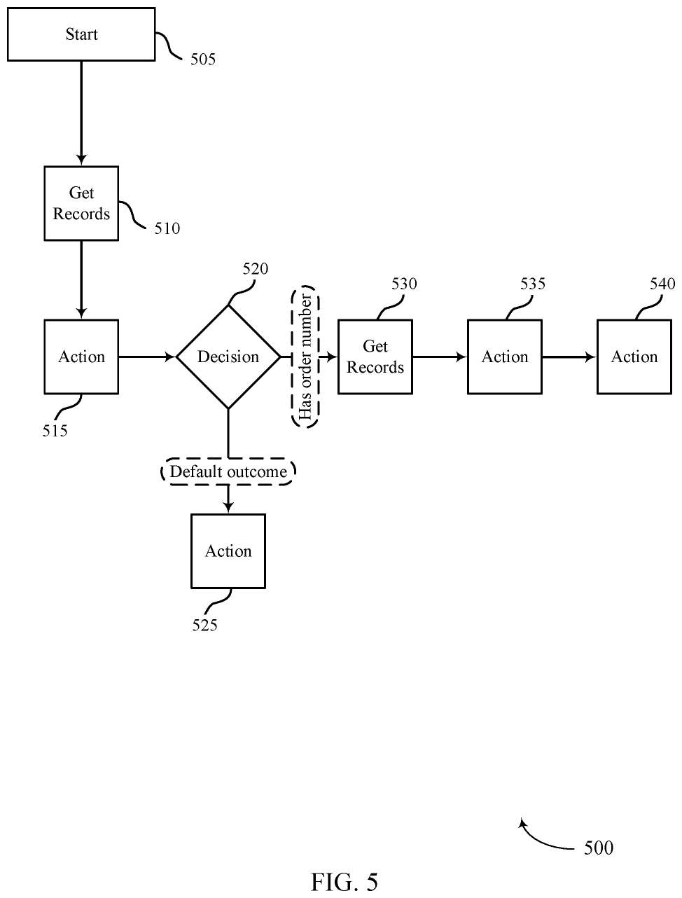

FIG. 5 illustrates an example of a process flow 500 that supports a screen-pop configuration using flow builder application in accordance with aspects of the present disclosure. The process flow 500 may be implemented by the application servers 210 described herein with reference to FIG. 2, and may support configuring screen-pops (e.g., user interface screen-pops) using a flow builder application. For example, as described with reference to FIGS. 3 and 4, the process flow 500 may be configured by a screen-pop service to include logic for obtaining records, making decisions, and performing actions (e.g., screen-pops) by a flow engine. The screen-pop service and the flow engine may be included in an application server.

As described herein, a user may build the process flow 500 using a flow builder application to configure a screen-pop (e.g., a synchronous screen-pop, an asynchronous screen-pop). The process flow 500 may be channel agnostic such that it may be built based on inputs from different channels (e.g., voice channels, messaging channels), and the process flow 500 may include instructions for implementing the screen-pop for an application (e.g., a telephony-integrated application).

At 505, the process flow 500 (e.g., an omni-channel flow) may start based on a user input to the flow builder application. In some examples, an application server may receive, via the user input, a set of parameters for configuring a screen-pop for the application, where the screen-pop may be executed in a user interface of the application based on a trigger. In some examples, the set of parameters may include a context record identifier, which may include a customer voice call record, an IVR input, a phone number, or any combination thereof. For example, a user of the application (e.g., a customer service agent) may receive an inbound voice call from a customer including the context record identifier. In some examples, the process flow 500 may start based on the user receiving the inbound voice call.

In some examples, the set of parameters may be used as input variables for configuring the screen-pop using the process flow 500. At 510, the application server may obtain one or more records associated with the set of parameters. For example, the user may receive the inbound voice call from the customer, which may include or otherwise refer to corresponding parameters such as an inbound voice call record and an IVR input. The application server may obtain a matching contact record within the application server based on the phone number associated with the inbound voice call.

At 515, the application server may perform an action (e.g., a screen-pop) based on the trigger. For example, the user may accept the inbound voice call (e.g., the trigger) which may trigger the application server to screen-pop the inbound voice call record and the matching contact record (e.g., the action) when the user accepts the inbound voice call. In some examples, the application server may search existing records, CRM records, or any combination thereof for the matching records. Additionally or alternatively, based on obtaining the matching contact record, the application server may obtain more information on the calling customer's account, and the application server may screen-pop the account (e.g., in a new tab in the application) to provide more context to the user.

At 520, the application server may make a decision to perform additional logic in the process flow 500. For example, the application server may retrieve a second set of parameters for configuring the screen-pop, which may include dynamic information such as an order number. The application server may retrieve the dynamic information from one or more data records (e.g., CRM records) or based on an additional user input (e.g., the customer may use a key pad on a phone to input the order number). In some examples, at 525, the application server may decide to perform an action based on the order number associated with the inbound voice call (e.g., a default outcome). For example, based on the context the order number provides, the application server may decide to route work with the order number to the customer. Additionally or alternatively, at 530, the application server may retrieve a matching order record based on the order number provided during the IVR stage of the inbound voice call. The matching order record may include the date and time the order was placed and any other information related to the order. In some examples, the application server may retrieve additional dynamic information based on different channel types (e.g., IVR input for voice channels, pre-chat form information for messaging channels) to add more logic to the process flow 500.

At 535, the application server may perform an action based on obtaining the matching order record at 530. For example, the application server may screen-pop the matching order record along with the inbound voice call record and the matching contact record when the user accepts the call (e.g., based on the trigger). In some examples, the records may be screen-popped in a tab, a browser window, or a page of the application. At 540, the application server may perform additional actions (e.g., RouteWork) based on the trigger. For example, the application server may screen-pop the records to additional target devices.

In some examples, the process flow 500 may support synchronous screen-pops, asynchronous screen-pops, or both. For example, for a synchronous screen-pop, the application server may perform the actions in the process flow 500 immediately after the user accepts the inbound voice call (e.g., the trigger). For an asynchronous screen-pop, the process flow 500 may be stored in a database, and the application server may query the database for the process flow 500 when a screen-pop may be relevant for the application.

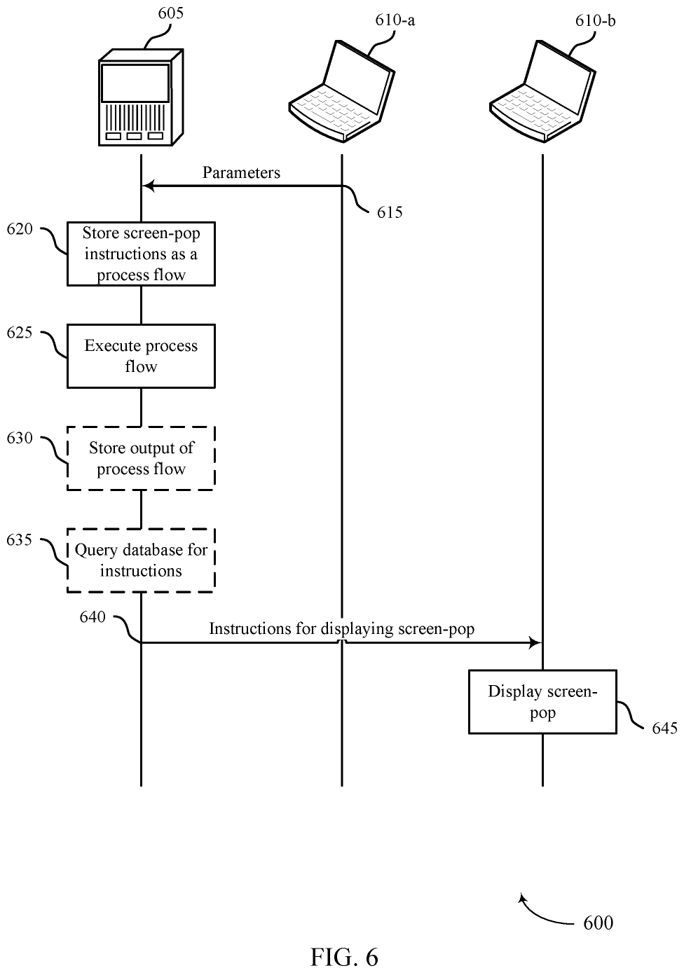

FIG. 6 illustrates an example of a process flow 600 that supports a screen-pop configuration using flow builder application in accordance with aspects of the present disclosure. The process flow 600 may implement aspects of the systems 100 and 200, or may be implemented by aspects of the systems 100 and 200. The process flow 600 may include an application server 605, a user device 610-a, and a user device 610-b. In the following description of the process flow 600, the operations between the application server 605, the user device 610-a, and the user device 610-b may be performed in different orders or at different times. Some operations may also be left out of the process flow 600, or other operations may be added. Although the application server 605, the user device 610-a, and the user device 610-b are shown performing the operations of the process flow 600, some aspects of some operations may also be performed by one or more other devices, or may be performed by other devices included in the process flow.

At 615, the application server 605 may receive, via user input of a flow builder application on the user device 610-a, a first set of parameters for configuring a user interface screen-pop for an application, where the user interface screen-pop includes a visual feature that appears in a user interface of the application in response to a trigger. The first set of parameters may include a context record identifier.

At 620, the application server 605 may store instructions for implementing the user interface screen-pop (e.g., a synchronous screen-pop) as a process flow according to the flow builder application. The process flow may include logic for obtaining records, making decisions, performing actions (e.g., screen-pops), or any combination thereof, which may be executed to configure the screen-pop.

At 625, the application server 605 may execute the process flow in response to receiving an indication of the trigger from the application, and in accordance with metadata associated with the trigger. For example, the application server 605 may obtain a matching contact record based on a phone number (e.g., metadata) associated with an inbound voice call (e.g., a trigger).

At 630, the application server 605 may optionally store an output of the process flow as instruction records corresponding to the user interface screen-pop in a database based on executing the process flow, where the user interface screen-pop is an asynchronous user interface screen-pop.

At 635, the application server 605 may optionally query the database for the instruction records based on one or more characteristics associated with the trigger. For example, for an asynchronous user interface screen-pop, the application server 605 may retrieve the stored instruction records from the database when a screen-pop may be relevant for the application.

At 640, the application server 605 may send instructions for displaying the user interface screen-pop to the application at the user device 610-b based on the indication of the trigger for a synchronous screen-pop or querying the database for an asynchronous screen-pop. At 645, the application at the user device 610-b may display the user interface screen-pop in accordance with the instructions.

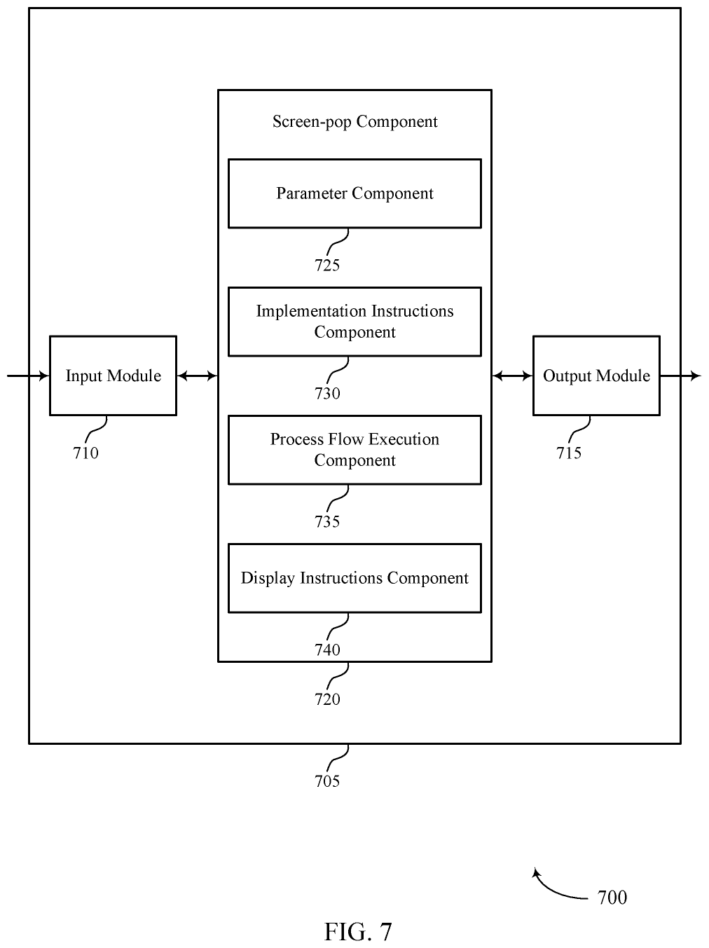

FIG. 7 shows a block diagram 700 of a device 705 that supports a screen-pop configuration using flow builder application in accordance with aspects of the present disclosure. The device 705 may include an input module 710, an output module 715, and a screen-pop component 720. The device 705 may also include a processor. Each of these components may be in communication with one another (e.g., via one or more buses).

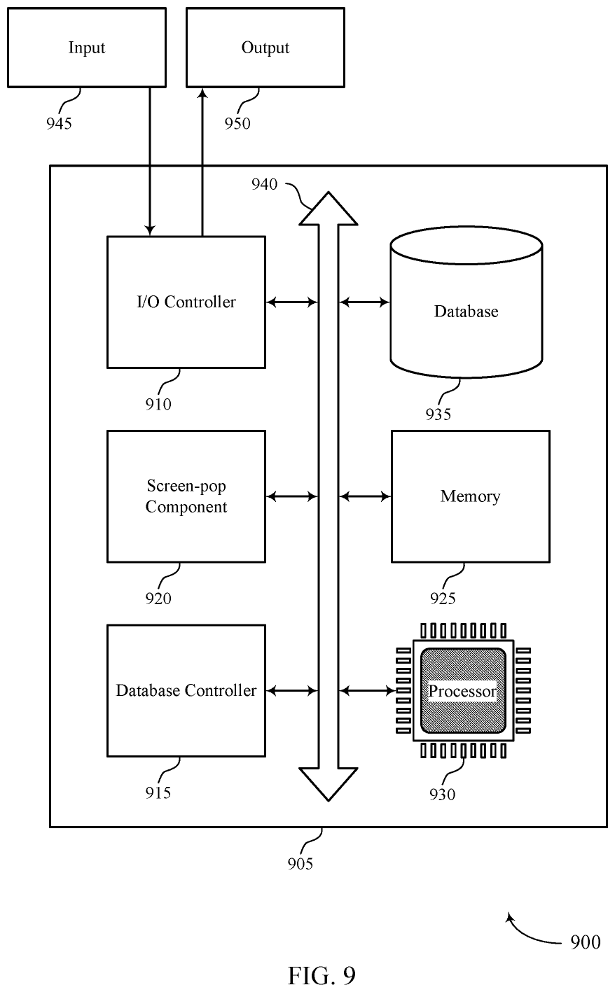

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the screen-pop component 720 to support screen-pop configuration using flow builder application. In some cases, the input module 710 may be a component of an I/O controller 910 as described with reference to FIG. 9.

The output module 715 may manage output signals for the device 705. For example, the output module 715 may receive signals from other components of the device 705, such as the screen-pop component 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the screen-pop component 720 may include a parameter component 725, an implementation instructions component 730, a process flow execution component 735, a display instructions component 740, or any combination thereof. In some examples, the screen-pop component 720, or various components thereof, may be configured to perform various operations (e.g., receiving, monitoring, transmitting) using or otherwise in cooperation with the input module 710, the output module 715, or both. For example, the screen-pop component 720 may receive information from the input module 710, send information to the output module 715, or be integrated in combination with the input module 710, the output module 715, or both to receive information, transmit information, or perform various other operations as described herein.

The screen-pop component 720 may support user interface configuration in accordance with examples as disclosed herein. The parameter component 725 may be configured as or otherwise support a means for receiving, via user input of a flow builder application, a first set of parameters for configuring a user interface screen-pop for an application, where the user interface screen-pop comprises a visual feature that appears in a user interface of the application in response to a trigger. The implementation instructions component 730 may be configured as or otherwise support a means for storing instructions for implementing the user interface screen-pop as a process flow according to the flow builder application. The process flow execution component 735 may be configured as or otherwise support a means for executing the process flow in response to receiving an indication of the trigger from the application and in accordance with metadata associated with the trigger. The display instructions component 740 may be configured as or otherwise support a means for sending instructions for displaying the user interface screen-pop to the application based at least in part on the indication of the trigger.

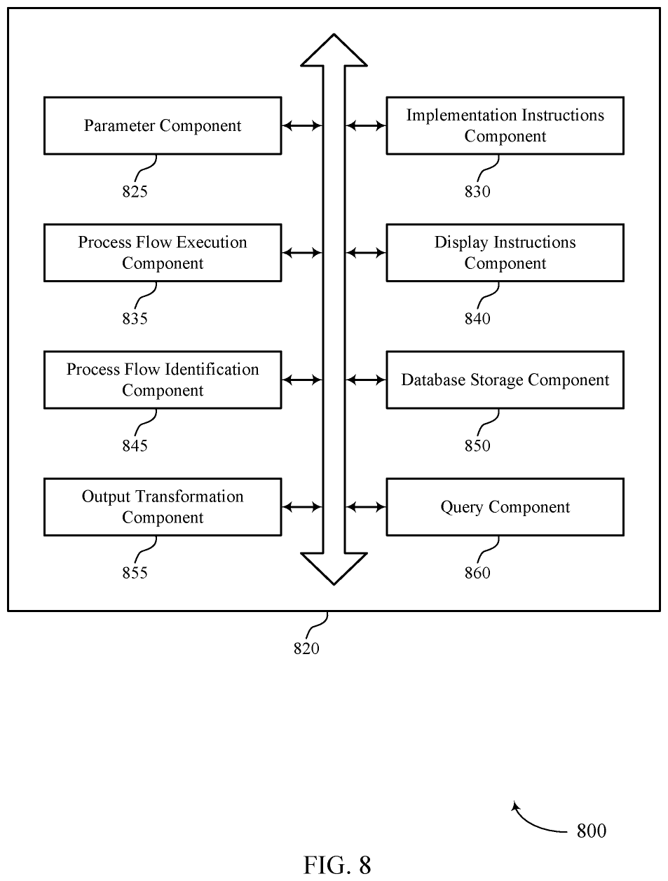

FIG. 8 shows a block diagram 800 of a screen-pop component that supports a screen-pop configuration using flow builder application in accordance with aspects of the present disclosure. The screen-pop component 820 may be an example of aspects of a system or a screen-pop component 720, or both, as described herein. The screen-pop component 820, or various components thereof, may be an example of means for performing various aspects of screen-pop configuration using flow builder application as described herein. For example, the screen-pop component 820 may include a parameter component 825, an implementation instructions component 830, a process flow execution component 835, a display instructions component 840, a process flow identification component 845, a database storage component 850, an output transformation component 855, a query component 860, or any combination thereof. Each of these components may communicate, directly or indirectly, with one another (e.g., via one or more buses).

The screen-pop component 820 may support user interface configuration in accordance with examples as disclosed herein. The parameter component 825 may be configured as or otherwise support a means for receiving, via user input of a flow builder application, a first set of parameters for configuring a user interface screen-pop for an application, where the user interface screen-pop comprises a visual feature that appears in a user interface of the application in response to a trigger. The implementation instructions component 830 may be configured as or otherwise support a means for storing instructions for implementing the user interface screen-pop as a process flow according to the flow builder application. The process flow execution component 835 may be configured as or otherwise support a means for executing the process flow in response to receiving an indication of the trigger from the application and in accordance with metadata associated with the trigger. The display instructions component 840 may be configured as or otherwise support a means for sending instructions for displaying the user interface screen-pop to the application based at least in part on the indication of the trigger.

In some examples, the process flow identification component 845 may be configured as or otherwise support a means for identifying the process flow, from a plurality of stored process flows, based at least in part on receiving the first set of parameters for configuring the user interface screen-pop for the application.

In some examples, the process flow identification component 845 may be configured as or otherwise support a means for identifying the process flow, from the plurality of stored process flows, based at least in part on one or more characteristics associated with the trigger.

In some examples, the parameter component 825 may be configured as or otherwise support a means for retrieving, from one or more data records, a second set of parameters for configuring the user interface screen-pop for the application, where executing the process flow is based at least in part on the second set of parameters.

In some examples, the database storage component 850 may be configured as or otherwise support a means for storing an output of the process flow as instruction records corresponding to the user interface screen-pop in a database based at least in part on executing the process flow, where the user interface screen-pop comprises an asynchronous user interface screen-pop.

In some examples, the query component 860 may be configured as or otherwise support a means for querying the database for the instruction records based at least in part on one or more characteristics associated with the trigger. In some examples, the display instructions component 840 may be configured as or otherwise support a means for sending instructions for displaying the user interface screen-pop to the application based at least in part on querying the database.

In some examples, the output transformation component 855 may be configured as or otherwise support a means for transforming an output of the process flow to the instructions for displaying the user interface screen-pop to the application based at least in part on executing the process flow, where sending the instructions for displaying the user interface screen-pop to the application is based at least in part on the transforming.

In some examples, the first set of parameters comprises a context record identifier and a second set of parameters comprises dynamic information. In some examples, the user interface screen-pop comprises a synchronous user interface screen-pop. In some examples, the instructions for displaying the user interface screen-pop to the application comprise at least one of a context record, a target type, a target configuration, or any combination thereof.

In some examples, the trigger comprises at least one of an inbound voice call, a customer identifier associated with the inbound voice call, a membership status for a customer, an order number input, an order modification input for a product, an outbound call associated with a prior callback request, a time period between a timing of the prior callback request and a timing of the outbound call, case information, or a combination thereof. In some examples, the flow builder application comprises a declarative user interface including one or more of a drag feature, a drop feature, a canvas, or a combination thereof.

FIG. 9 shows a diagram of a system 900 including a device 905 that supports a screen-pop configuration using flow builder application in accordance with aspects of the present disclosure. The device 905 may be an example of or include the components of a device 705 as described herein. The device 905 may include components for bi-directional data communications including components for transmitting and receiving communications, such as a screen-pop component 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and ROM. The memory 925 may store computer-readable, computer-executable software including instructions that, when executed, cause the processor 930 to perform various functions described herein. In some cases, the memory 925 may contain, among other things, a basic input/output system (BIOS) which may control basic hardware or software operation such as the interaction with peripheral components or devices.

The processor 930 may include an intelligent hardware device, (e.g., a general-purpose processor, a digital signal processor (DSP), a central processing unit (CPU), a microcontroller, an application-specific integrated controller (ASIC), a field programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting screen-pop configuration using flow builder application).

The screen-pop component 920 may support user interface configuration in accordance with examples as disclosed herein. For example, the screen-pop component 920 may be configured as or otherwise support a means for receiving, via user input of a flow builder application, a first set of parameters for configuring a user interface screen-pop for an application, where the user interface screen-pop comprises a visual feature that appears in a user interface of the application in response to a trigger. The screen-pop component 920 may be configured as or otherwise support a means for storing instructions for implementing the user interface screen-pop as a process flow according to the flow builder application. The screen-pop component 920 may be configured as or otherwise support a means for executing the process flow in response to receiving an indication of the trigger from the application and in accordance with metadata associated with the trigger. The screen-pop component 920 may be configured as or otherwise support a means for sending instructions for displaying the user interface screen-pop to the application based at least in part on the indication of the trigger.

By including or configuring the screen-pop component 920 in accordance with examples as described herein, the device 905 may support techniques for configuring a screen-pop using a flow builder application, which may improve the efficacy of the screen-pop and increase workflow efficiencies, which may improve user experience.

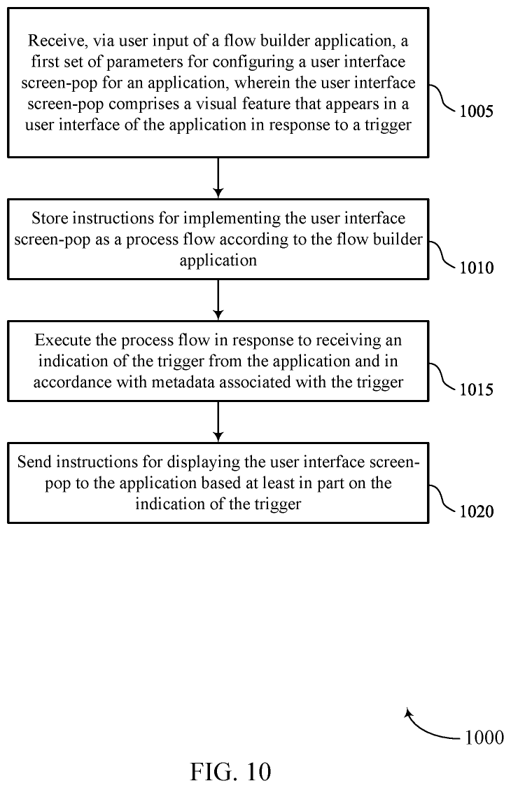

FIG. 10 shows a flowchart illustrating a method 1000 that supports a screen-pop configuration using flow builder application in accordance with aspects of the present disclosure. The operations of the method 1000 may be implemented by an application server or its components as described herein. For example, the operations of the method 1000 may be performed by an application server as described with reference to FIGS. 1 through 9. In some examples, an application server may execute a set of instructions to control the functional elements of the application server to perform the described functions. Additionally or alternatively, the application server may perform aspects of the described functions using special-purpose hardware.

At 1005, the method may include receiving, via user input of a flow builder application, a first set of parameters for configuring a user interface screen-pop for an application, where the user interface screen-pop comprises a visual feature that appears in a user interface of the application in response to a trigger. The operations of 1005 may be performed in accordance with examples as disclosed herein. In some examples, aspects of the operations of 1005 may be performed by a parameter component 825 as described with reference to FIG. 8.

At 1010, the method may include storing instructions for implementing the user interface screen-pop as a process flow according to the flow builder application. The operations of 1010 may be performed in accordance with examples as disclosed herein. In some examples, aspects of the operations of 1010 may be performed by an implementation instructions component 830 as described with reference to FIG. 8.

At 1015, the method may include executing the process flow in response to receiving an indication of the trigger from the application and in accordance with metadata associated with the trigger. The operations of 1015 may be performed in accordance with examples as disclosed herein. In some examples, aspects of the operations of 1015 may be performed by a process flow execution component 835 as described with reference to FIG. 8.

At 1020, the method may include sending instructions for displaying the user interface screen-pop to the application based at least in part on the indication of the trigger. The operations of 1020 may be performed in accordance with examples as disclosed herein. In some examples, aspects of the operations of 1020 may be performed by a display instructions component 840 as described with reference to FIG. 8.

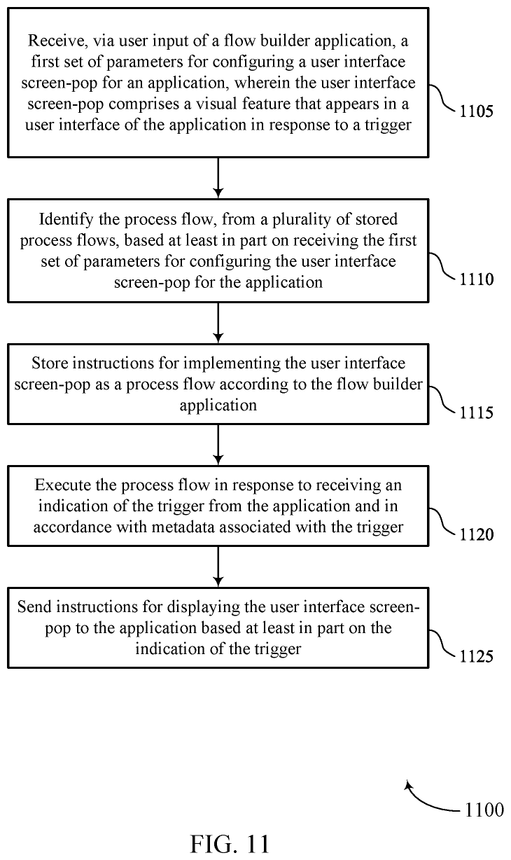

FIG. 11 shows a flowchart illustrating a method 1100 that supports a screen-pop configuration using flow builder application in accordance with aspects of the present disclosure. The operations of the method 1100 may be implemented by an application server or its components as described herein. For example, the operations of the method 1100 may be performed by an application server as described with reference to FIGS. 1 through 9. In some examples, an application server may execute a set of instructions to control the functional elements of the application server to perform the described functions. Additionally or alternatively, the application server may perform aspects of the described functions using special-purpose hardware.

At 1105, the method may include receiving, via user input of a flow builder application, a first set of parameters for configuring a user interface screen-pop for an application, where the user interface screen-pop comprises a visual feature that appears in a user interface of the application in response to a trigger. The operations of 1105 may be performed in accordance with examples as disclosed herein. In some examples, aspects of the operations of 1105 may be performed by a parameter component 825 as described with reference to FIG. 8.

At 1110, the method may include identifying the process flow, from a plurality of stored process flows, based at least in part on receiving the first set of parameters for configuring the user interface screen-pop for the application. The operations of 1110 may be performed in accordance with examples as disclosed herein. In some examples, aspects of the operations of 1110 may be performed by a process flow identification component 845 as described with reference to FIG. 8.

At 1115, the method may include storing instructions for implementing the user interface screen-pop as a process flow according to the flow builder application. The operations of 1115 may be performed in accordance with examples as disclosed herein. In some examples, aspects of the operations of 1115 may be performed by an implementation instructions component 830 as described with reference to FIG. 8.

At 1120, the method may include executing the process flow in response to receiving an indication of the trigger from the application and in accordance with metadata associated with the trigger. The operations of 1120 may be performed in accordance with examples as disclosed herein. In some examples, aspects of the operations of 1120 may be performed by a process flow execution component 835 as described with reference to FIG. 8.

At 1125, the method may include sending instructions for displaying the user interface screen-pop to the application based at least in part on the indication of the trigger. The operations of 1125 may be performed in accordance with examples as disclosed herein. In some examples, aspects of the operations of 1125 may be performed by a display instructions component 840 as described with reference to FIG. 8.

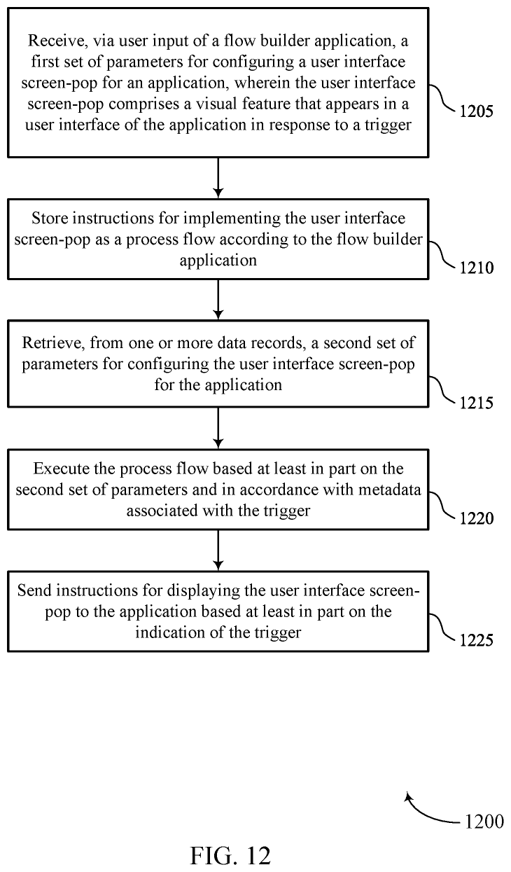

FIG. 12 shows a flowchart illustrating a method 1200 that supports a screen-pop configuration using flow builder application in accordance with aspects of the present disclosure. The operations of the method 1200 may be implemented by an application server or its components as described herein. For example, the operations of the method 1200 may be performed by an application server as described with reference to FIGS. 1 through 9. In some examples, an application server may execute a set of instructions to control the functional elements of the application server to perform the described functions. Additionally or alternatively, the application server may perform aspects of the described functions using special-purpose hardware.

At 1205, the method may include receiving, via user input of a flow builder application, a first set of parameters for configuring a user interface screen-pop for an application, where the user interface screen-pop comprises a visual feature that appears in a user interface of the application in response to a trigger. The operations of 1205 may be performed in accordance with examples as disclosed herein. In some examples, aspects of the operations of 1205 may be performed by a parameter component 825 as described with reference to FIG. 8.

At 1210, the method may include storing instructions for implementing the user interface screen-pop as a process flow according to the flow builder application. The operations of 1210 may be performed in accordance with examples as disclosed herein. In some examples, aspects of the operations of 1210 may be performed by an implementation instructions component 830 as described with reference to FIG. 8.

At 1215, the method may include retrieving, from one or more data records, a second set of parameters for configuring the user interface screen-pop for the application. The operations of 1215 may be performed in accordance with examples as disclosed herein. In some examples, aspects of the operations of 1215 may be performed by a parameter component 825 as described with reference to FIG. 8.

At 1220, the method may include executing the process flow based on the second set of parameters and in accordance with metadata associated with the trigger. The operations of 1220 may be performed in accordance with examples as disclosed herein. In some examples, aspects of the operations of 1220 may be performed by a process flow execution component 835 as described with reference to FIG. 8.

At 1225, the method may include sending instructions for displaying the user interface screen-pop to the application based at least in part on the indication of the trigger. The operations of 1225 may be performed in accordance with examples as disclosed herein. In some examples, aspects of the operations of 1225 may be performed by a display instructions component 840 as described with reference to FIG. 8.

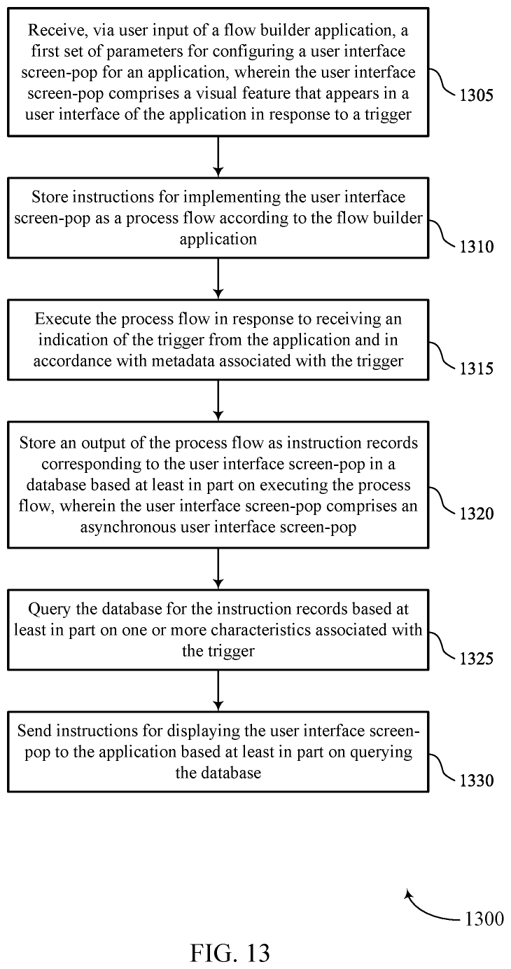

FIG. 13 shows a flowchart illustrating a method 1300 that supports a screen-pop configuration using flow builder application in accordance with aspects of the present disclosure. The operations of the method 1300 may be implemented by an application server or its components as described herein. For example, the operations of the method 1300 may be performed by an application server as described with reference to FIGS. 1 through 9. In some examples, an application server may execute a set of instructions to control the functional elements of the application server to perform the described functions. Additionally or alternatively, the application server may perform aspects of the described functions using special-purpose hardware.

At 1305, the method may include receiving, via user input of a flow builder application, a first set of parameters for configuring a user interface screen-pop for an application, where the user interface screen-pop comprises a visual feature that appears in a user interface of the application in response to a trigger. The operations of 1305 may be performed in accordance with examples as disclosed herein. In some examples, aspects of the operations of 1305 may be performed by a parameter component 825 as described with reference to FIG. 8.

At 1310, the method may include storing instructions for implementing the user interface screen-pop as a process flow according to the flow builder application. The operations of 1310 may be performed in accordance with examples as disclosed herein. In some examples, aspects of the operations of 1310 may be performed by an implementation instructions component 830 as described with reference to FIG. 8.

At 1315, the method may include executing the process flow in response to receiving an indication of the trigger from the application and in accordance with metadata associated with the trigger. The operations of 1315 may be performed in accordance with examples as disclosed herein. In some examples, aspects of the operations of 1315 may be performed by a process flow execution component 835 as described with reference to FIG. 8.

At 1320, the method may include storing an output of the process flow as instruction records corresponding to the user interface screen-pop in a database based at least in part on executing the process flow, where the user interface screen-pop comprises an asynchronous user interface screen-pop. The operations of 1320 may be performed in accordance with examples as disclosed herein. In some examples, aspects of the operations of 1320 may be performed by a database storage component 850 as described with reference to FIG. 8.

At 1325, the method may include querying the database for the instruction records based at least in part on one or more characteristics associated with the trigger. The operations of 1325 may be performed in accordance with examples as disclosed herein. In some examples, aspects of the operations of 1325 may be performed by a query component 860 as described with reference to FIG. 8.

At 1330, the method may include sending instructions for displaying the user interface screen-pop to the application based at least in part on querying the database. The operations of 1330 may be performed in accordance with examples as disclosed herein. In some examples, aspects of the operations of 1330 may be performed by a display instructions component 840 as described with reference to FIG. 8.

A method for user interface configuration is described. The method may include receiving, via user input of a flow builder application, a first set of parameters for configuring a user interface screen-pop for an application, wherein the user interface screen-pop comprises a visual feature that appears in a user interface of the application in response to a trigger, storing instructions for implementing the user interface screen-pop as a process flow according to the flow builder application, executing the process flow in response to receiving an indication of the trigger from the application and in accordance with metadata associated with the trigger, and sending instructions for displaying the user interface screen-pop to the application based at least in part on the indication of the trigger.

An apparatus for user interface configuration is described. The apparatus may include a processor, memory coupled with the processor, and instructions stored in the memory. The instructions may be executable by the processor to cause the apparatus to receive, via user input of a flow builder application, a first set of parameters for configuring a user interface screen-pop for an application, wherein the user interface screen-pop comprises a visual feature that appears in a user interface of the application in response to a trigger, store instructions for implementing the user interface screen-pop as a process flow according to the flow builder application, execute the process flow in response to receiving an indication of the trigger from the application and in accordance with metadata associated with the trigger, and send instructions for displaying the user interface screen-pop to the application based at least in part on the indication of the trigger.

Another apparatus for user interface configuration is described. The apparatus may include means for receiving, via user input of a flow builder application, a first set of parameters for configuring a user interface screen-pop for an application, wherein the user interface screen-pop comprises a visual feature that appears in a user interface of the application in response to a trigger, means for storing instructions for implementing the user interface screen-pop as a process flow according to the flow builder application, means for executing the process flow in response to receiving an indication of the trigger from the application and in accordance with metadata associated with the trigger, and means for sending instructions for displaying the user interface screen-pop to the application based at least in part on the indication of the trigger.

A non-transitory computer-readable medium storing code for user interface configuration is described. The code may include instructions executable by a processor to receive, via user input of a flow builder application, a first set of parameters for configuring a user interface screen-pop for an application, wherein the user interface screen-pop comprises a visual feature that appears in a user interface of the application in response to a trigger, store instructions for implementing the user interface screen-pop as a process flow according to the flow builder application, execute the process flow in response to receiving an indication of the trigger from the application and in accordance with metadata associated with the trigger, and send instructions for displaying the user interface screen-pop to the application based at least in part on the indication of the trigger.

Some examples of the method, apparatuses, and non-transitory computer-readable medium described herein may further include operations, features, means, or instructions for identifying the process flow, from a plurality of stored process flows, based at least in part on receiving the first set of parameters for configuring the user interface screen-pop for the application.

Some examples of the method, apparatuses, and non-transitory computer-readable medium described herein may further include operations, features, means, or instructions for identifying the process flow, from the plurality of stored process flows, based at least in part on one or more characteristics associated with the trigger.

Some examples of the method, apparatuses, and non-transitory computer-readable medium described herein may further include operations, features, means, or instructions for retrieving, from one or more data records, a second set of parameters for configuring the user interface screen-pop for the application, wherein executing the process flow may be based at least in part on the second set of parameters.

Some examples of the method, apparatuses, and non-transitory computer-readable medium described herein may further include operations, features, means, or instructions for storing an output of the process flow as instruction records corresponding to the user interface screen-pop in a database based at least in part on executing the process flow, wherein the user interface screen-pop comprises an asynchronous user interface screen-pop.

Some examples of the method, apparatuses, and non-transitory computer-readable medium described herein may further include operations, features, means, or instructions for querying the database for the instruction records based at least in part on one or more characteristics associated with the trigger and sending instructions for displaying the user interface screen-pop to the application based at least in part on querying the database.

Some examples of the method, apparatuses, and non-transitory computer-readable medium described herein may further include operations, features, means, or instructions for transforming an output of the process flow to the instructions for displaying the user interface screen-pop to the application based at least in part on executing the process flow, wherein sending the instructions for displaying the user interface screen-pop to the application may be based at least in part on the transforming.

In some examples of the method, apparatuses, and non-transitory computer-readable medium described herein, the first set of parameters comprises a context record identifier and a second set of parameters comprises dynamic information.

In some examples of the method, apparatuses, and non-transitory computer-readable medium described herein, the user interface screen-pop comprises a synchronous user interface screen-pop.

In some examples of the method, apparatuses, and non-transitory computer-readable medium described herein, the instructions for displaying the user interface screen-pop to the application comprise at least one of a context record, a target type, a target configuration, or any combination thereof.

In some examples of the method, apparatuses, and non-transitory computer-readable medium described herein, the trigger comprises at least one of an inbound voice call, a customer identifier associated with the inbound voice call, a membership status for a customer, an order number input, an order modification input for a product, an outbound call associated with a prior callback request, a time period between a timing of the prior callback request and a timing of the outbound call, case information, or a combination thereof.

In some examples of the method, apparatuses, and non-transitory computer-readable medium described herein, the flow builder application comprises a declarative user interface including one or more of a drag feature, a drop feature, a canvas, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for user interface configuration, comprising:
receiving, via user input of a flow builder application, a first set of parameters for configuring a user interface screen-pop for an application, wherein the user interface screen-pop comprises a visual feature that appears in a user interface of the application in response to a trigger;
storing instructions for implementing the user interface screen-pop as a process flow according to the flow builder application;
executing the process flow in response to receiving an indication of the trigger from the application and in accordance with metadata associated with the trigger; and
sending instructions for displaying the user interface screen-pop to the application based at least in part on the indication of the trigger.

2. The method of claim 1, further comprising:
identifying the process flow, from a plurality of stored process flows, based at least in part on receiving the first set of parameters for configuring the user interface screen-pop for the application.

3. The method of claim 2, further comprising:
identifying the process flow, from the plurality of stored process flows, based at least in part on one or more characteristics associated with the trigger.

4. The method of claim 1, further comprising:
retrieving, from one or more data records, a second set of parameters for configuring the user interface screen-pop for the application, wherein executing the process flow is based at least in part on the second set of parameters.

5. The method of claim 1, further comprising:
storing an output of the process flow as instruction records corresponding to the user interface screen-pop in a database based at least in part on executing the process flow, wherein the user interface screen-pop comprises an asynchronous user interface screen-pop.

6. The method of claim 5, further comprising:
querying the database for the instruction records based at least in part on one or more characteristics associated with the trigger; and
sending instructions for displaying the user interface screen-pop to the application based at least in part on querying the database.

7. The method of claim 1, further comprising:
transforming an output of the process flow to the instructions for displaying the user interface screen-pop to the application based at least in part on executing the process flow, wherein sending the instructions for displaying the user interface screen-pop to the application is based at least in part on the transforming.

8. The method of claim 1, wherein the first set of parameters comprises a context record identifier and a second set of parameters comprises dynamic information.

9. The method of claim 1, wherein the user interface screen-pop comprises a synchronous user interface screen-pop.

10. The method of claim 1, wherein the instructions for displaying the user interface screen-pop to the application comprise at least one of a context record, a target type, a target configuration, or any combination thereof.

11. The method of claim 1, wherein the trigger comprises at least one of an inbound voice call, a customer identifier associated with the inbound voice call, a membership status for a customer, an order number input, an order modification input for a product, an outbound call associated with a prior callback request, a time period between a timing of the prior callback request and a timing of the outbound call, case information, or a combination thereof.

12. The method of claim 1, wherein the flow builder application comprises a declarative user interface including one or more of a drag feature, a drop feature, a canvas, or a combination thereof.

13. An apparatus for user interface configuration, comprising:
a processor;
memory coupled with the processor; and
instructions stored in the memory and executable by the processor to cause the apparatus to:
receive, via user input of a flow builder application, a first set of parameters for configuring a user interface screen-pop for an application, wherein the user interface screen-pop comprises a visual feature that appears in a user interface of the application in response to a trigger;
store instructions for implementing the user interface screen-pop as a process flow according to the flow builder application;
execute the process flow in response to receiving an indication of the trigger from the application and in accordance with metadata associated with the trigger; and
send instructions for displaying the user interface screen-pop to the application based at least in part on the indication of the trigger.

14. The apparatus of claim 13, wherein the instructions are further executable by the processor to cause the apparatus to:
identify the process flow, from a plurality of stored process flows, based at least in part on receiving the first set of parameters for configuring the user interface screen-pop for the application.

15. The apparatus of claim 14, wherein the instructions are further executable by the processor to cause the apparatus to:
identify the process flow, from the plurality of stored process flows, based at least in part on one or more characteristics associated with the trigger.

16. The apparatus of claim 13, wherein the instructions are further executable by the processor to cause the apparatus to:
retrieve, from one or more data records, a second set of parameters for configuring the user interface screen-pop for the application, wherein executing the process flow is based at least in part on the second set of parameters.

17. The apparatus of claim 13, wherein the instructions are further executable by the processor to cause the apparatus to:
store an output of the process flow as instruction records corresponding to the user interface screen-pop in a database based at least in part on executing the process flow, wherein the user interface screen-pop comprises an asynchronous user interface screen-pop.

18. The apparatus of claim 17, wherein the instructions are further executable by the processor to cause the apparatus to:
query the database for the instruction records based at least in part on one or more characteristics associated with the trigger; and
send instructions for displaying the user interface screen-pop to the application based at least in part on querying the database.

19. The apparatus of claim 13, wherein the instructions are further executable by the processor to cause the apparatus to:
transform an output of the process flow to the instructions for displaying the user interface screen-pop to the application based at least in part on executing the process flow, wherein sending the instructions for displaying the user interface screen-pop to the application is based at least in part on the transforming.

20. A non-transitory computer-readable medium storing code for user interface configuration, the code comprising instructions executable by a processor to:
receive, via user input of a flow builder application, a first set of parameters for configuring a user interface screen-pop for an application, wherein the user interface screen-pop comprises a visual feature that appears in a user interface of the application in response to a trigger;
store instructions for implementing the user interface screen-pop as a process flow according to the flow builder application;
execute the process flow in response to receiving an indication of the trigger from the application and in accordance with metadata associated with the trigger; and
send instructions for displaying the user interface screen-pop to the application based at least in part on the indication of the trigger.
